(19) United States
(12) Patent Application Publication
(10) Pub. No.: US 2009/0116678 A1
(43) Pub. Date: May 7, 2009

(54) Headset with fit adjustments and magnetic accessories

(76) Inventors: JoeBen Bevirt, Santa Cruz, CA (US); David Eliot Scheinman, Woodside, CA (US); Fred Italo Polito, Santa Cruz, CA (US)

Correspondence Address: MICHAEL A. GUTH, 2-2905 EAST CLILFF DRIVE, SANTA CRUZ, CA, 95062, US

(21) Appl. No.: 12/077,075

(22) Filed: Mar. 14, 2008

Related U.S. Application Data
(63) Continuation-in-part of application No. 11/543,467, filed on Oct. 4, 2006.
Application No. 11/543,467 is a continuation-in-part of application No. 11/488,957, filed on Jul. 19, 2006.
(60) Provisional application No. 60/918,378, filed on Mar. 15, 2007.

(51) Int. Cl. H04R 25/00

(52) U.S. Cl. 381/381

(57) ABSTRACT

A headset which includes a metal or metallic housing to which various accessory components can be attached. These components can include an ear loop, a necklace for the holding of the headset while not being worn on the ear, an external mount, and other components. The components include a magnet which facilitates mounting to the headset. The components are not restricted to a particular attach point, which enhances the ability of the user to adjust the geometry for better fit. An earloop with an inelastic central range allowing for better fit.

### CROSS-REFERENCE TO RELATED APPLICATIONS

This application is a continuation-in-part of U.S. patent application Ser. No. 11/543,467 to Bevirt et al., filed Oct. 4, 2006, which is a continuation-in-part of U.S. patent application Ser. No. 11/488,957 to Bevirt et al., filed Jul. 19, 2006, both of which are hereby incorporated by reference in their entirety. This application claims priority to U.S. Provisional Application No. 60/918,378 filed Mar. 15, 2007.

### BACKGROUND

1. Field of the Invention

This invention relates to wireless communication, and more specifically to improvements in wireless headsets for use with cellular telephones and similar devices.

2. Description of Related Art

A headset may be used in conjunction with a telephone device for several reasons. With a headset, the user is relived of the need to hold the phone and thus retains his or her hands free to perform other functions. Headsets also function to position the earphone and microphone portions of a telephone close to the user's head to provide for clearer reception and transmission of audio signals with less interference from background noise. Headsets may be used with telephones, computers, cellular telephones, and other devices.

The wireless industry has launched several after-market products to free the user form holding the phone while making phone calls. For example, various headsets are manufactured with an earpiece connected to a microphone and most of these headsets or hands-free kits are compatible with any phone brand or model. A possible headset can be plugged-in to the phone and comprise a microphone connected via wires to the headset so that the microphone, when in position, can appropriately capture the voice of the user. Other headsets are built in with a Bluetooth chip, or other wireless means, so that the voice conversation can be wirelessly diverted from the phone to the earpiece of the headset. The Bluetooth radio chip acts as a connector between the headset and a Bluetooth chip of the cell-phone.

An important aspect for headsets is that they be able to fit the head and facial geometry of a variety of users, yet most headsets typically do not allow for adjustment to meet variations between users. Also, a headset may be more convenient if there is an easy way to carry it with the user when the user desires not to have it mounted on the ear.

What is called for is a headset which enhances the ability of the user to adjust the headset geometry to fit the user's head and face, as well as a headset which enhances the convenience of using and storing the headset.

### SUMMARY

A headset which includes a metal or metallic housing to which various accessory components can be attached. These components can include an ear loop, a necklace for the holding of the headset while not being worn on the ear, an external mount, and other components. The components include a magnet which facilitates mounting to the headset. The components are not restricted to a particular attach point, which enhances the ability of the user to adjust the geometry for better fit. An earloop with an inelastic central range allowing for better fit.

### BRIEF DESCRIPTION OF THE DRAWINGS

FIG. 1 is a sketch of the back side of a headset according to some embodiments of the present invention.

FIG. 2 is a sketch of the inner side of a headset with a magnetically attached ear loop according to some embodiments of the present invention.

FIG. 3 is a side view of a headset according to some embodiments of the present invention.

FIG. 4 is a sketch of an exploded view of a headset according to some embodiments of the present invention.

FIG. 5 is a view of a headset with an extendible boom according to some embodiments of the present invention.

FIGS. 6A-C are views of a headset with an extendible boom according to some embodiments of the present invention.

FIGS. 7A-B are views of an ear loop assembly according to some embodiments of the present invention.

FIG. 8 is a view of an ear loop assembly according to some embodiments of the present invention.

FIG. 9 is a view of mount supporting a headset according to some embodiments of the present invention.

FIGS. 10A-C are sketches of a user wearing a necklace supporting a headset according to some embodiments of the present invention.

FIGS. 11A-B are views of a headset according to some embodiments of the present invention.

FIG. 12 is a view of a headset according to some embodiments of the present invention.

FIG. 13 is a view of a headset according to some embodiments of the present invention.

FIG. 14 is a view of a headset according to some embodiments of the present invention.

FIG. 15 is a view of an earloop according to some embodiments of the present invention.

FIG. 16 is a cross-sectional view of an earloop according to some embodiments of the present invention.

### DETAILED DESCRIPTION

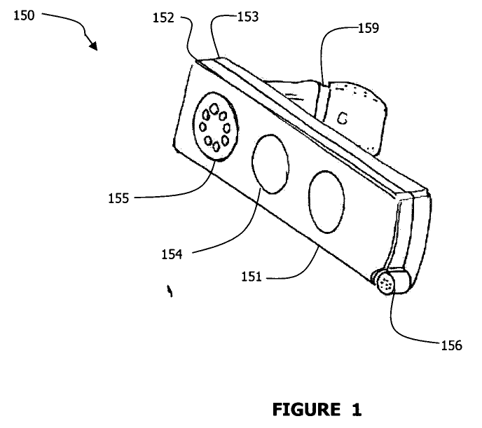

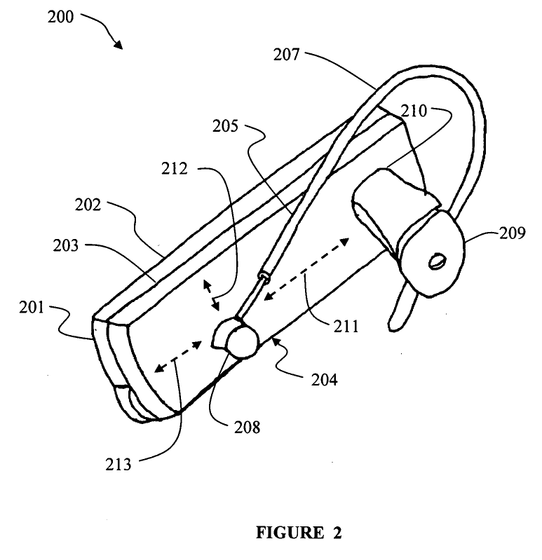

FIG. 1 illustrates a headset 150 according to some embodiments of the present invention. The main body 151 may consist of an inner housing 153 and an outer housing 152. The inner housing 153, which is the side of the main body 151 adjacent to the user's head, may be made of a magnetically permeable material to allow for the attachment of accessories using a magnet. The use of a magnetically permeable material such as a metal housing may give an additional advantage of allowing for a very thin wall thickness which may facilitate the construction of a very small headset. The headset may be used in conjunction with accessories which use a magnet to attach to the housing. An earpiece 159 is attached to the main body 151. One or more buttons 151, 154 may be positioned on the outer housing 152 of the main body 151 and may be used to implement functionalities of the headset 150. An LED panel 155 may indicate function. A microphone 156 is seen.

In some embodiments, the microphone may be a deployable microphone that deploys with the use of a microphone boom. The microphone boom may be stowed into the main body 151. The microphone is seen to be at an inner edge of the main body 151, and not in the center of the main body. In some embodiments, the microphone boom may stow into a position along the main body.

Although the present invention has been disclosed using embodiments of wireless headsets, other types of headsets including wired headsets may be utilized in other embodiments.

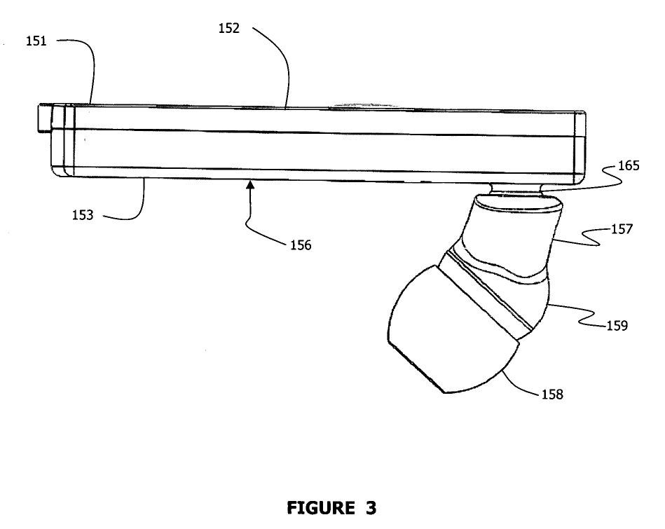

Referring to FIGS. 1 and 3, the earpiece 159 consists of an earpiece base 157 and an ear engaging body 158. The earpiece 159 may be attached to the main body 151 with a flexible joint. The flexible joint may allow the relative position and angle of the main body of the headset and the earpiece to be adapted for users with differing ear shapes and geometries. The ear engaging body 158 may be adapted to fit into the ear canal of the user, and may be adapted to support the headset on the user's head without additional attachments in some embodiments. In some embodiments, additional attachments may be used with the headset.

FIG. 2 is a sketch illustrating a headset 200 with an attached ear loop 205. The headset 200 has a main body 201 which has an inner housing 203 and an outer housing 202. An earpiece 209 is attached to the main body 201 with a joint 210. In some embodiments, the joint 210 is a flexible joint. In some embodiments, the joint 210 is a ball and socket joint. The surface 204 of the inner housing 203 provides a mounting plane for an ear loop 205. The ear loop 205 has an ear hook 207 adapted to be worn over the user's ear to assist in the wearing of the headset 200. The ear loop base 206 supports the ear hook 207 and provides an attachment to the inner surface 204 of the inner housing 203. The ear loop base 206 has a magnet 208 which allows for the attachment of the ear loop 205 to the inner surface 204 of the inner housing 203. The inner housing 203 is made from a magnetically permeable material which allows the attachment of the magnet 208 to the surface 204 of the inner housing. In some embodiments, the entire inner housing is made from a material to which a magnet will adhere. In some embodiments, all or part of the surface 204 of the inner housing 203 is made from a material to which a magnetic material will adhere. The term magnetically permeable refers to a material to which a magnet will attach in the context of this application.

The ear loop base 206 may be positioned by the user to a position that better fits the particular geometry of the user's ear and head. The distance 211 between the earpiece 209 and the ear loop base 206 may be altered by the placement of the ear loop base 206 on the surface 204 of the inner housing 203. The ear loop base 206 may be moved vertically 212 or horizontally 213. The magnet 206 attaching the ear loop base 206 to the inner housing 203 may be of a strength that allows relatively easy removal from the headset but of sufficient strength that the ear loop 205 will not dislodge from the headset while being worn by the user in normal operation.

The headset can be used by the user in a geometry that best suits the user. In addition, the ear loop may be removed from the main body should the user so desire. The headset may be worn using just the earpiece as the attachment to the user in some cases. However, the user may desire a more secure attachment to the head and then can utilize the removable ear loop as well. In addition, the removal of the ear loop may allow for safer storage of the headset when not being worn. The magnetically permeable surface on the main body also allows for attachment of other accessories, or methods of storage, with the ear loop either still attached or removed.

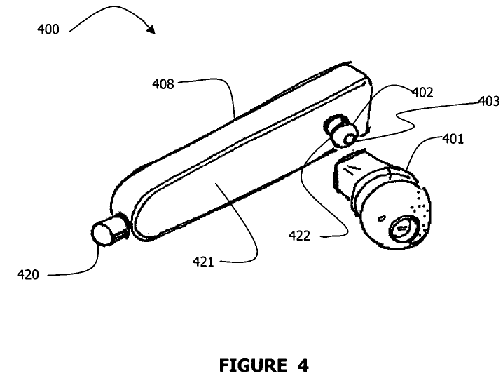

FIG. 4 illustrates an exploded view of a headset 400 according to some embodiments of the present invention showing a flexible joint between the headset main body and the earpiece. A headset 400 has a main body 408 adapted to receive wireless communication. A microphone 420 is seen at the far end of the headset main body 408 from which an earpiece junction 402 is attached. The microphone 420 is seen in close proximity to the headset main body 408, but may have an extendable boom to deploy the microphone closer to the mouth of the user.

The earpiece junction 402 attaches the main body 408 to the earpiece 401, seen in exploded view in FIG. 4. The earpiece junction 402 is attached to the main body 408 along the interior surface 421 of the main body. The attachment of the earpiece 401 to the earpiece junction 402 creates a flexible joint which allows for the adjustment of the position of the earpiece relative to the main body. The earpiece may then be adjusted by the user to best fit the user. In some embodiments, the earpiece junction 402 is a ball and socket configuration which includes a socket engaging end surface 422 which is mated into an internal socket receiving cavity attached to the base 405 of the earpiece 401. The mated flexible joint allows for movement in three orthogonal axes. In some embodiments, the relative positions of the two sides of the flexible joint may be reversed; the socket engaging end surface may be on the earpiece side and the cavity may be attached to the main body of the housing. In some embodiments, the internal socket receiving cavity 406 is substantially residing within the base of the earpiece.

The socket engaging end surface 422 has a central hole 403 through the earpiece junction 402 in some embodiments. In some embodiments, the central hole 403 is a conduit through which wires pass to a speaker within the earpiece. In some embodiments, the central hole 403 is a sound channel through which sound is channeled from a speaker on the main housing side of the flexible joint. The ear engaging body 407 is adapted to fit into the ear canal of the user and to support the headset 400 on the user in some embodiments. Although described in the context of a speaker, the audio device may be a driver or other appropriate device.

With the combination of adjusting the relative angle of the earpiece to the main body, as well as the position of the ear loop relative to the earpiece, the user is able to adjust the headset to maximize fit and comfort.

Although the illustrations of embodiments show an earpiece, in some embodiments the headset may not have an external earpiece. For example, the headset may have a flush mounted, recessed, or raised speaker (or other audio driver) on the main body of the headset. The movable ear loop assembly may be used with such a headset as well.

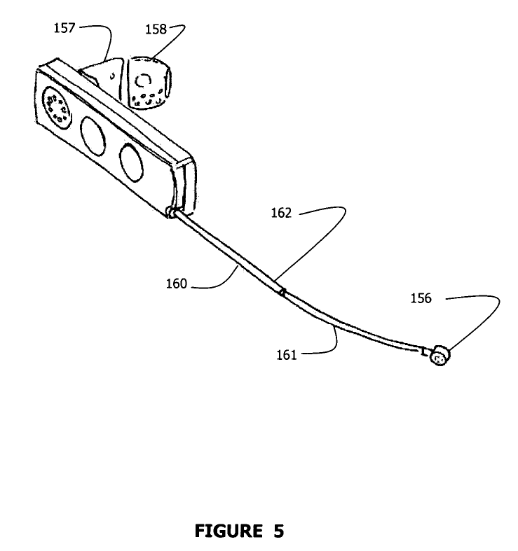

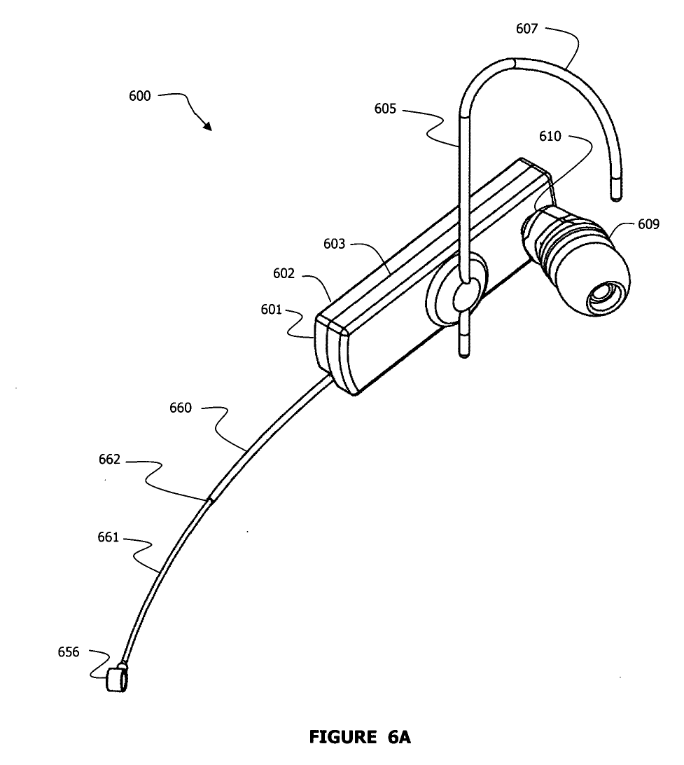

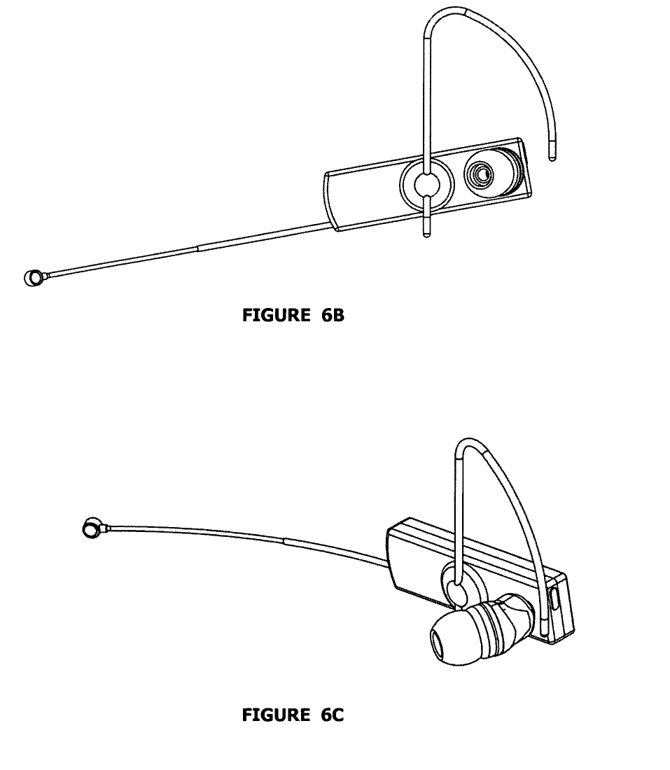

FIG. 5 illustrates the headset 150 with the microphone 156 in the deployed position. The microphone 156 can be seen now deployed from the main body 151. The microphone 156 has been deployed with an extendable microphone boom 162 which was stowed within the main body 151. The microphone boom 162 consists of a first boom section 160 and a second boom section 161. The microphone boom 162 is a telescoping boom in this embodiment; the second boom section 161 stows into the first boom section 160 when the microphone boom 162 is stowed. In some embodiments, both boom sections are made from a superelastic material. In some embodiments, one or both of the boom sections may be curved in their deployed state. In some embodiments, the boom may be restricted from rotation relative to the main body 151. In some embodiments, the boom sections may be restricted from rotation relative to each other. This may be accomplished by having the telescoping sections be made from an oval profile, or through other methods. In some embodiments utilizing a telescoping microphone boom, the microphone boom may be substantially longer than the length of the main body of the headset along its long axis. For example, the main body of the headset, with the microphone stowed and the microphone boom within the main body, may be approximately 2.5 inches in length. The microphone boom may extend out approximately 4 inches in such an embodiment. In some embodiments, the second boom section 161 is curved in its relaxed state, and the first boom section 160 is straight. The second boom section 161 is straightened as it is stowed back into the first boom section 160, and in turn as both boom sections are stowed back into the housing. In some embodiments, the microphone boom is made from a single section, or a plurality of sections.

The user may choose to partially deploy the microphone based upon the user's preference, or also based upon the user's head size and shape. The partial or full microphone deployment, in combination with the adjustable ear loop, or in combination with the adjustable ear loop and the flexible joint of the earpiece, or some combination of all of the above, gives the user the ability to adjust the headset for best fit and function.

FIGS. 6A-C illustrate a headset 600 with an movably attached ear loop assembly 605 with an extendable microphone boom in the deployed position. The headset 600 has a main body 601 which has an inner housing 603 and an outer housing 602. An earpiece 609 is attached to the main body 601 with a joint 610. In some embodiments, the joint 610 is a flexible joint. In some embodiments, the joint 610 is a ball and socket joint. The surface 604 of the inner housing 603 provides a mounting plane for an ear loop assembly 605. The ear loop assembly 605 has an ear loop 607 adapted to be worn over the user's ear to assist in the wearing of the headset 600. The shape of the ear loop may vary, as discussed below. The ear loop base 606 supports the ear loop 607 and provides an attachment to the inner surface 604 of the inner housing 603. The ear loop base 606 has a magnet within it which allows for the attachment of the ear loop assembly 605 to the inner surface 604 of the inner housing 603. The inner housing 603 is made from a magnetically permeable material which allows the attachment of the magnet in the ear loop base 606 to the surface 604 of the inner housing. In some embodiments, the entire inner housing is made from a material to which a magnet will adhere. In some embodiments, all of part of the surface 604 of the inner housing 603 is made from a material to which a magnetic material will adhere. The term magnetically permeable refers to a material to which a magnet will attach in the context of this application.

The ear loop base 606 may be positioned by the user to a position that better fits the particular geometry of the user's ear and head. The distance between the earpiece 609 and the ear loop base 606 may be altered by the placement of the ear loop base 606 on the surface 604 of the inner housing 603. The ear loop base may be moved vertically or horizontally. The magnet attaching the ear loop base to the inner housing may be of a strength that allows relatively easy removal from the headset but of sufficient strength that the ear loop will not dislodge from the headset while being worn by the user in normal operation. In some operational modes, the user will desire to use the headset without the ear loop assembly attached to the headset. For example, the headset may stay well mounted to a user's ear during the activity in which they are engaged, such as sitting or driving. While engaging in other activities which may more rigorously jostle the headset, the user may desire to use the ear loop in order to achieve a more secure fit. Some users may desire to use the ear loop during all use.

In some embodiments, the magnetically permeable material to which the magnet of the ear loop base will adhere may not be external to the main surface of the inner face of the main body. The magnetically permeable may be a layer under the surface in some embodiments.

The microphone 656 has been deployed with an extendable microphone boom 662 which was stowed within the main body 601. The microphone boom 662 consists of a first boom section 660 and a second boom section 661. The microphone boom 662 is a telescoping boom in this embodiment; the second boom section 661 stows into the first boom section 660 when the microphone boom 662 is stowed.

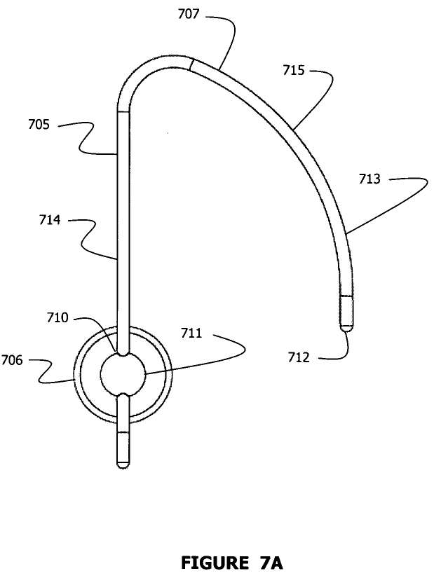

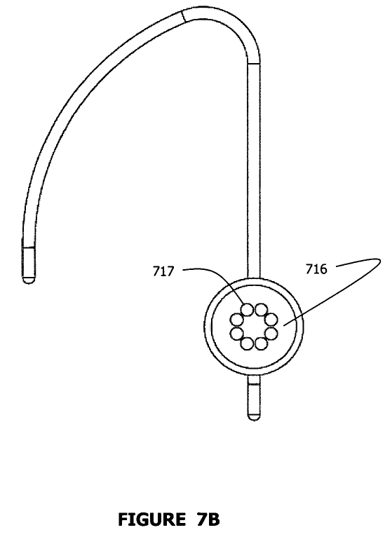

FIGS. 7A-B illustrate an ear loop assembly 705 according to some embodiments of the present invention. The ear loop base 706 may have a hole 710 in a raised center 711 into which the ear loop 707 is inserted and captured with a friction fit. The first section 714 of the ear loop 707 may be predominantly straight in order that it can be slid further into the hole 710, allowing for the user to customize the sizing and fit of the ear loop. A second section 713 of the ear loop 707 may be curved in order to better fit the ear of the user. In some embodiments, the first section and the second section of the ear loop are of a spring material, such as stainless steel. In some embodiment, the first section 714 may be of a spring material, and the second section 713 may be of a more malleable material, allowing for easier bending and forming of the curved section to better fit the user's ear. In some embodiments, the ear loop may be made of a super elastic material. The ear loop may be covered with a heat shrink tubing or other material for reasons of comfort or for other reasons. The ear loop may have an end cap 712 which may be of metal in some embodiments.

The ear loop base 706 may consist of a magnet coated with a material such as TCE in some embodiments. The back surface 716 of the ear loop base 706 may be substantially flat to allow for better magnetic attachment to the magnetically permeable surface of the headset to which it will be magnetically attached. The magnet may be of neodymium iron boron in some embodiments. The magnet may be 12 mm in diameter and coated with TPE of a thickness of 0.3 mm in some embodiments. There may holes 717 in the coating through to the magnet in some embodiments.

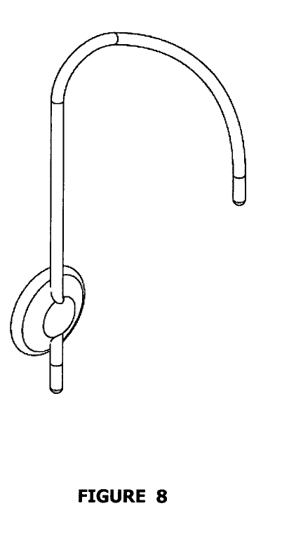

FIG. 8 illustrates another shape of ear loop according to some embodiments of the present invention.

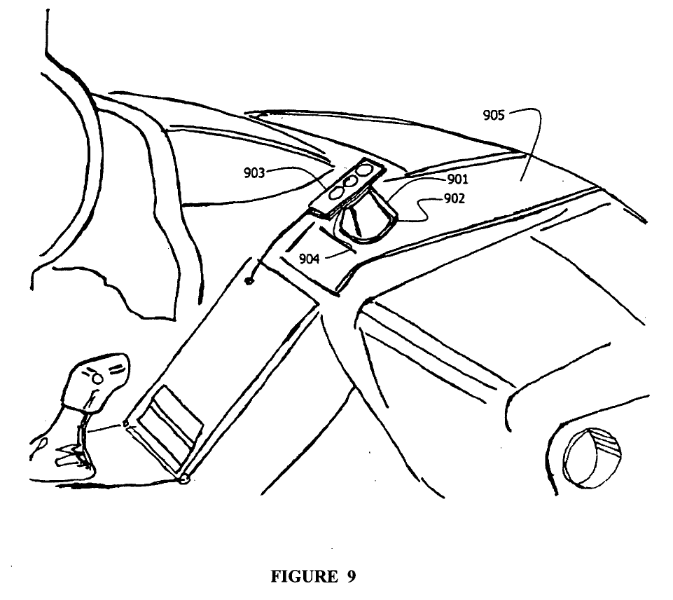

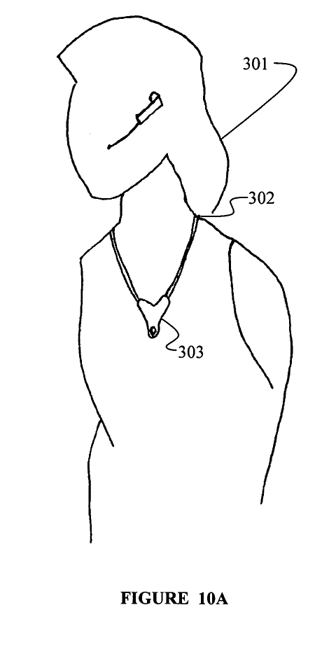

FIG. 9 illustrates a mount for mounting of a headset according to some embodiments of the present invention. A mount 901 is seen attached to a dashboard 905 of a vehicle. The mount 901 may be affixed with an attachment layer 902, which may be adhesive, hook and loop fastening, or other means. The mount 901 has a magnet 904 mounted along its top surface. The magnet 904 may be exposed along the surface or may be below the top surface with a coating over it. The headset 903 is seen magnetically attached to the mount 901. A mount may be used in a variety of other locations as well.

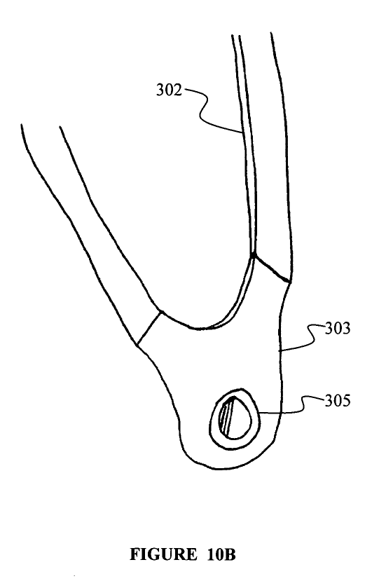

FIGS. 10A-C illustrate an apparatus for carrying a headset according to some embodiments of the present invention. A user 301 is seen with a necklace 302 worn around the neck. The necklace 302 has a magnetic clip 303 on it. The magnetic clip includes a magnet 305 adapted for magnetically attaching a headset with a magnetically permeable surface or layer. The magnet may be exposed or may be covered with an external layer. The magnet may be a disc of neodymium iron boron in some embodiments. The magnetic clip 303 allows for the headset 304 to be attached to the user when not in use.

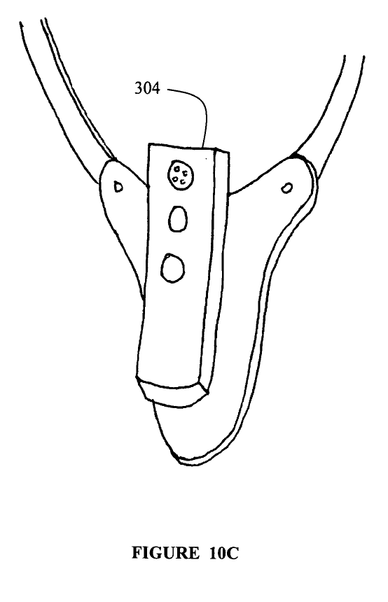

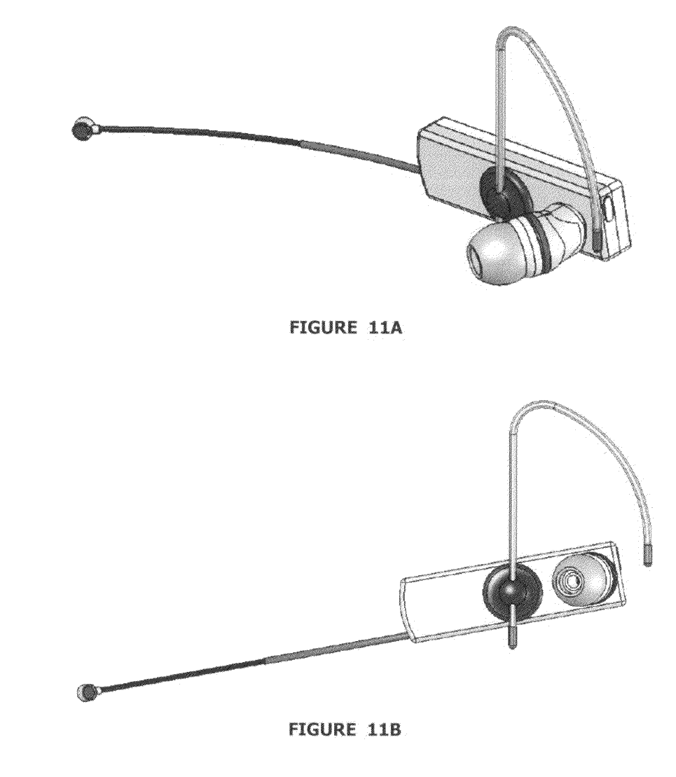

FIGS. 11A-B are views of a headset according to some embodiments of the present invention.

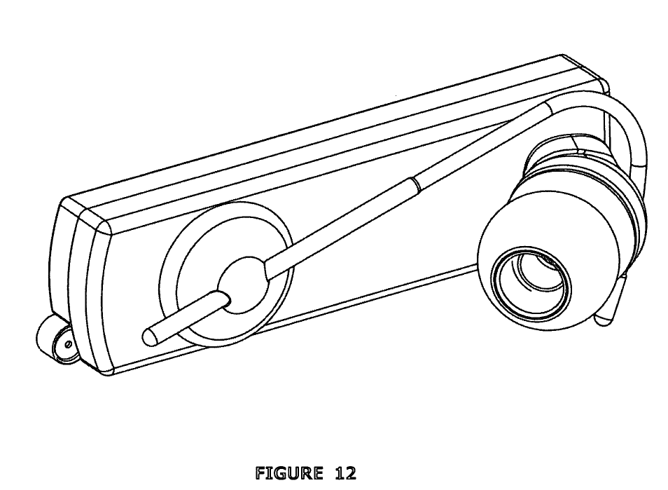

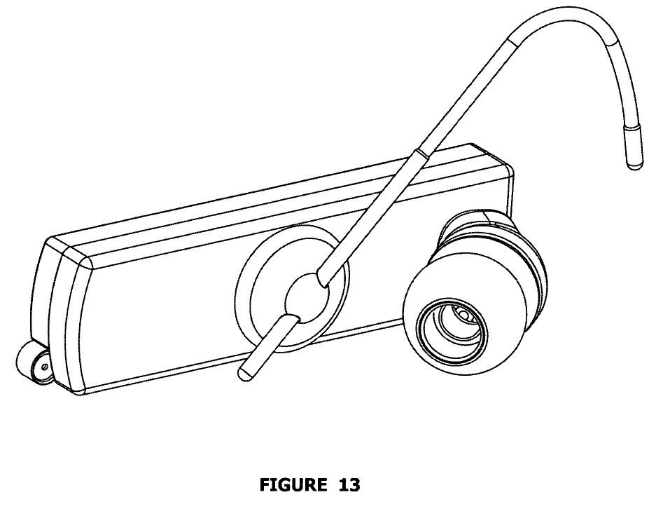

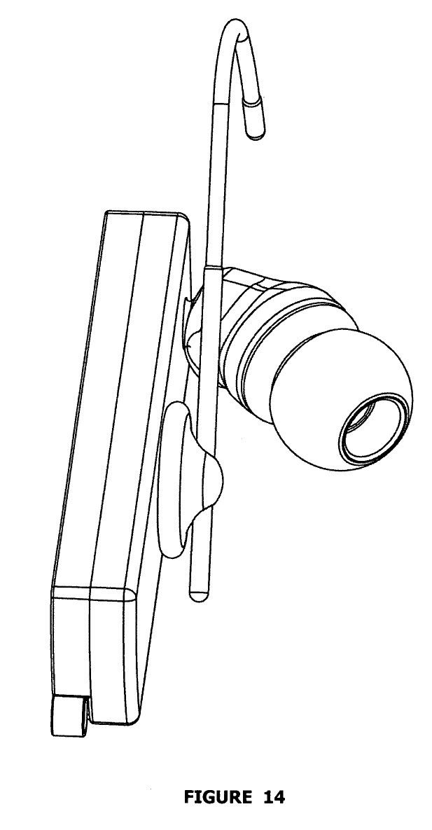

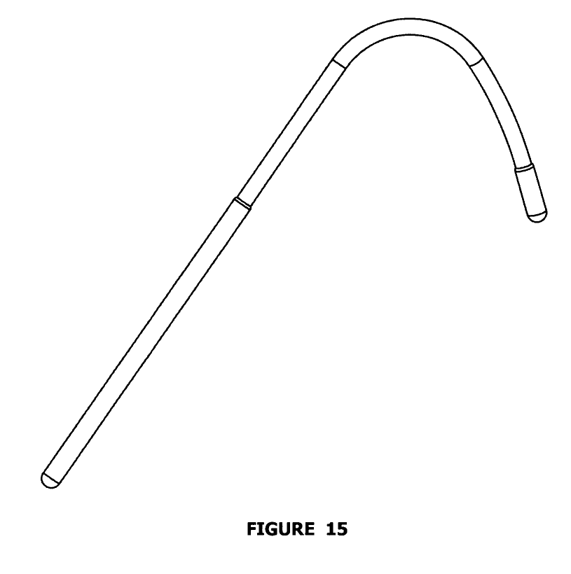

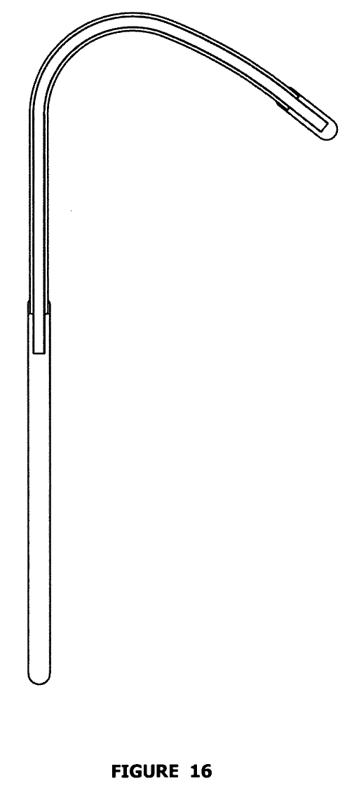

FIGS. 12, 13, and 14 illustrate a headset according to some embodiments of the present invention. The headset is seen with a shorter ear loop. The ear loop may have a curved length of 15-30 mm. As seen in cross-section in FIG. 16, the curved portion of the ear loop may be of separate material, which may be covered in plastic, rubber, or another type of thin coating. The shorter ear loop may be much easier to put on, and may also allow for easier and better stowage of the ear loop. The ear loop may have an end cap and coatings similar to the previously described ear loops.

The separate material of the curved portion of the ear loop may be a shape memory alloy (SMA). In some embodiments, the SMA may be in superelastic form, with the shape of the ear loop set into the material. In this case, the ear loop will have extreme durability as it can be bent through misuse and return to its original shape without set or breakage.

In another embodiment of the present invention, the curved portion of the ear loop may be of an SMA with a different property, allowing for a central inelastic range.

The ear loop has been designed to allow for some particularly useful properties. To allow for further adaptability of the ear loop to the particular facial geometry and preferences of a user, the ear loop may be easily positioned within a central range. The central range 208 may have a first end 206 and a second end 207. Within the central range, the boom may be easily pushed into a position desired by the user, and it will stay in that position. Thus, an individual user may set the ear loop to a position that the user finds comfortable or otherwise appropriate for use. When the ear loop is pushed past the limits of the central range, into the areas outside the central range, the ear loop will have elastic properties. The ear loop may pushed far outside the central range and will spring back to, or near to, the limit area of the central range. The center of this central range may be the nominal original position set during the first heat treatment.

An exemplary embodiment of the ear loop is as follows. The first section 203 has an outside diameter of 1.40-1.44 mm, a wall thickness of 0.07-0.12 mm, and a length of 48 mm. The second section 204 has an outside diameter of 1.08-1.12 mm, and wall thickness of 0.07-0.12 mm, and a length of 47.5 mm. The material is a NiTi material starting with an ingot of binary NiTi alloy produced by smelting Sponge Ti and electrolytic Ni. The ingot is forged into a 35 mm diameter rod, rolled into a thin 8 mm diameter NiTi rod, a hole is then put into the rod to form a tube, and then the tube is drawn into the tubing of the desired geometry over several steps. The tubing is placed in a form, which holds it in a curved position, and treated. The initial treatment is a heat treatment of about 480-580 C for 10-30 minutes. This initial treatment sets the bend of the aforementioned ear loop. This results in the ear loop described above having superelastic properties.

A further treatment is used to create the central region of inelastic deformation around the set bent shape. The material is then heat treated at 300-550 deg C. for 30 min to 2 hours. After the second treatment, the central region of inelastic deformation will be seen in the material.

A typical material will have a central bending range that is elastic, wherein small deflections behave in a spring like fashion. As the material is deflected further, an elastic limit is reached wherein the stress has exceeded the amount under which the material retains its elastic properties. With further deflection, plastic deformation occurs, and the material will not return to its original position upon unloading.

A superelastic material, such as Nitinol (NiTi) may exhibit elasticity over large levels of strain. The increased flexibility obtained in these materials by undergoing large elastic strain can improve their performance. At low levels of stress, the material exits in an austenite phase. Upon further loading, the material undergoes a stress-induced transformation from the austenite phase to a martensite phase. The material behaves as linear elastic in both austentite and martensite phases, however, the modulus of elasticity in the two phases is different. During the stress induced transformation from austenite to martensite there is very little change is stress, but a large increase in strain. Beyond the transitions region in the martensite phase ultimately results in permanent unrecoverable set in the material, while unloading for cases that do not reach the transformation state follow the elastic modulus.

The ear loop with the second heat treatment behaves differently and offers other distinct advantages. The central inelastic range allows the user to position the ear loop around the user's face in a manner that is more specific to a particular user. For example, the material may be bent at differing radii of curvature at different points along the length of the boom. Also, although the boom is positionable in this central range, the boom will be exceptionally durable for the consumer because the elastic properties outside the central range will greatly lower the likelihood of damage to the boom if it is sat upon or otherwise mistreated by the user.

The properties of the ear loop with the central range may be due to the setting of the martensite start (Ms) and the austenite finish (Af) temperatures. In most cases, a material will demonstrate elastic properties immediately upon the onset of strain. However, it is possible to set the material properties such that this is not the case, and that some strain must be added before the material moves into its pseudo-elastic range. This may then allow for inelastic material properties in a central range, and after the addition of enough strain induced stress, such as by moving through this central range, the elastic properties are seen. The effects described with regard to the ear loop above may be due to having room temperature (or the ear loop operation temperature) lying between the Ms and Af temperatures.

The inelastic properties in the central range are most probably a result of this being a region where the NiTi alloy is transitioning from austenite to a martensite phase. The highly elastic properties outside the central range are most probably due to an elastic martensite deflection, although the invention is not limited to a single theory.

As the stress during bending is related to the bending section, with material furthest from the bending center seeing the highest stress under bending, the breadth of the central inelastic range may be altered depending upon the selected bending section. For example, a smaller diameter tube will bend further before a certain stress is reached relative to a larger diameter tube. Thus, through manipulation of the bending cross-section one can manipulate the breadth of the central range.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

I claim:

1. A headset comprising:
a main body; and
an ear loop, said ear loop having an inelastic central bending range.

2. The headset of claim 1 wherein said ear loop has an outer elastic bending range, wherein said outer elastic bending range is outside of said inelastic central bending range.

3. The headset of claim 2 wherein said ear loop comprises a shape memory alloy.
